(19) United States
(12) Patent Application Publication
(10) Pub. No.: US 2024/0291813 A1
(43) Pub. Date: Aug. 29, 2024

(54) SECURE MEETING SYSTEM AND METHOD

(71) Applicant: The Government of the United States of America, as represented by the Secretary of Homeland Security

(72) Inventor: Mark A. Fry, Marco Island, FL (US)

(73) Assignee: The Government of the United States of America, as represented by the Secretary of Homeland Security, Washington, DC (US)

(21) Appl. No.: 18/384,619

(22) Filed: Oct. 27, 2023

Related U.S. Application Data
(60) Provisional application No. 63/448,845, filed on Feb. 28, 2023.

(51) Int. Cl. H04L 9/40; H04L 65/1073; H04L 65/1093

(52) U.S. Cl. CPC H04L 63/0861; H04L 63/102; H04L 65/1073; H04L 65/1093

(57) ABSTRACT

In an example, a meeting system for communication between a client and a host includes a meeting server; a first computer; a secure meeting kiosk including a kiosk interior for a person to enter to attend a first meeting session, the secure meeting kiosk including an access portal for entry into and exit from the kiosk interior; a second computer disposed inside the secure meeting kiosk; a digital lock connected to the access portal to lock the access portal in a locked state and unlock the access portal in an unlocked state; and an external biometric capture device configured to obtain outside biometric information of the person when the person is outside of the kiosk interior. The digital lock switches between the unlocked state and the locked state based at least in part on the outside biometric information obtained by the external biometric capture device.

### CROSS-REFERENCE TO RELATED APPLICATIONS

The application claims the benefit of priority from U.S. Provisional Patent Application No. 63/448,845, filed Feb. 28, 2023, entitled SECURE REMOTE INTERVIEW SYSTEM AND METHOD, the disclosure of which is incorporated by reference in its entirety.

### SUMMARY STATEMENT OF GOVERNMENT INTEREST

The present invention was made with support from the United States Department of Homeland Security (DHS) and by an employee of DHS in the performance of their official duties. The U.S. Government has certain rights in this invention.

### FIELD

The discussion below relates generally to communications and, more particularly, to communications including remote communications such as a remote interview between a person/client and a host.

### BACKGROUND

Microsoft has entered the race to build a metaverse inside Teams, just days after Facebook rebranded to Meta in a push to build virtual spaces for both consumers and businesses. Microsoft is bringing Mesh, a collaborative platform for virtual experiences, directly into Microsoft Teams. It is part of a big effort to combine the company's mixed reality and HoloLens work with meetings and video calls that anyone can participate in thanks to animated avatars.

Microsoft Mesh appears to be the future of Microsoft Teams meetings. Microsoft is building on efforts such as Together Mode and other experiments for making meetings more interactive, after months of people working from home and adjusting to hybrid work. The Together Mode is an effort to address meeting fatigue. Mesh may further help reduce the cognitive overload of having to be on video calls all day long. Microsoft Teams users will not need to put a VR headset on to use the 3D avatars in the metaverse environment. These avatars can represent users both in 2D and 3D meetings, so that users can each choose to have an animated version of themselves if they do not feel like turning on their webcams.

Microsoft will use AI (Artificial Intelligence) to listen to the user's voice and then animate the user's avatar. If the user switches to a more immersive 3D meeting, then these animations will also include raising the avatar's hands when the user hits the raise hand option or animate emoji around the user's avatar.

### SUMMARY

Embodiments of the present invention are directed to secure communications technologies to support virtual interviewing, document presentation/validation, digital signature-identity, and proof of liveness. The processes may occur within a single computer application. A key feature is initial enrollment.

In some embodiments, an electronic system enables secure, validated interviews with prospective applicants for an entity by enrolling them into the entity's process. This overall process may involve the use of a secure interview system that can be labeled as a kiosk and that may support remote communications. The kiosk may be a small structure with one or more open sides and be used to vend merchandise (such as newspapers) and/or services (such as film developing). The kiosk may be a small stand-alone structure having components or devices for providing information and/or services on a computer screen. The kiosk is capable of being configured to become a secure meeting space.

Entities that schedule in-person interviews on premises to start their enrollment process can have a very large backlog. By using kiosks that embody both features (i.e., vending of goods and/or services and provisioning of information and/or services), an entity may securely install them at remote locations to decrease the backlog significantly.

In accordance with an aspect, a meeting system for communication between a client and a host comprises: a meeting server configured to provide a meeting server platform; a first computer configured to connect to the meeting server; a secure meeting kiosk for providing a connection to the meeting server, the secure meeting kiosk including a kiosk interior for a person to enter to attend a first meeting session, the secure meeting kiosk including an access portal for entry into and exit from the kiosk interior; a second computer disposed inside the secure meeting kiosk and configured to connect to the meeting server; a digital lock connected to the access portal to lock the access portal in a locked state and unlock the access portal in an unlocked state; and an external biometric capture device configured to obtain outside biometric information of the person when the person is outside of the kiosk interior. The digital lock switches between the unlocked state and the locked state based at least in part on the outside biometric information obtained by the external biometric capture device.

In accordance with another aspect, a meeting system for communication between a client and a host comprises: a meeting server configured to provide a meeting server platform; a first computer configured to connect to the meeting server; a secure meeting kiosk for providing a connection to the meeting server, the secure meeting kiosk including a kiosk interior for a person to enter to attend a first meeting session, the secure meeting kiosk including an access portal for entry into and exit from the kiosk interior; a second computer disposed inside the secure meeting kiosk and configured to connect to the meeting server; and an inside biometric capture device disposed in the kiosk interior to capture inside biometric information of the person when the person is in the kiosk interior. The meeting server platform includes: a meeting registration process unit configured to receive meeting registration data for the client to meet online with the host; a biographic capture module configured to receive biographic information from the client; a first biometric capture module configured to receive first biometric information from the client; an identity generator configured to generate an identity for the client based on the biographic information and the first biometric information; an access code generator configured to generate an access code for the client having the identity to provide physical access to the kiosk interior; a meeting scheduler configured to schedule the first meeting session based on the meeting registration data; and a test mode logic configured to generate a test mode for the meeting system to operate in (i) a premade test mode to verify proper system operation of the meeting system or (ii) a live test mode to allow the person in the kiosk interior to provide live responses to requests generated by the meeting system.

Another aspect is directed to a meeting method for communication between a host using a first computer and a client using a second computer which is disposed in a secure meeting kiosk in a meeting system. The secure meeting kiosk includes a kiosk interior for a person to enter to attend a first meeting session and an access portal for entry into and exit from the kiosk interior. The first computer and the second computer are connected with a meeting server providing a meeting server platform. The meeting method comprises: receiving, by the meeting server, meeting registration data for the client to meet online with the host; receiving, by the meeting server, biographic information from the client; receiving, by the meeting server, first biometric information from the client; generating an identity for the client, by the meeting server, based on the biographic information and the first biometric information; generating, by the meeting server, an access code for the client having the identity to provide physical access to the kiosk interior; scheduling the first meeting session, by the meeting server, based on the meeting registration data; and generating, by the meeting server, a test mode for the meeting system to operate in (i) a premade test mode to verify proper system operation of the meeting system or (ii) a live test mode to allow the person in the kiosk interior to provide live responses to requests generated by the meeting system.

Other features and aspects of various examples and embodiments will become apparent to those of ordinary skill in the art from the following detailed description which discloses, in conjunction with the accompanying drawings, examples that explain features in accordance with embodiments. This summary is not intended to identify key or essential features, nor is it intended to limit the scope of the invention, which is defined solely by the claims.

### BRIEF DESCRIPTION OF THE DRAWINGS

The attached drawings help explain the embodiments described below.

FIG. 1 is a block diagram schematically illustrating an example of a meeting system between a host and a client/individual/user.

FIG. 2 is a block diagram schematically illustrating elements of a kiosk in the meeting system of FIG. 1 according to an embodiment.

FIG. 3 is a block diagram schematically illustrating elements of a meeting server in the meeting system of FIG. 1 according to an embodiment.

FIG. 3A shows an example of the biographic data response logic.

FIG. 3B shows an example of the biometric data response logic.

FIG. 4 shows a flow diagram illustrating an example of a meeting setup process by the meeting server.

FIG. 5 shows a flow diagram illustrating an example of a premade test mode process.

FIG. 6 shows a flow diagram illustrating an example of a live test mode process.

FIG. 7 illustrates a computing system including logic according to an embodiment.

### DETAILED DESCRIPTION

A number of examples or embodiments of the present invention are described, and it should be appreciated that the present invention provides many applicable inventive concepts that can be embodied in a variety of ways. The embodiments discussed herein are merely illustrative of ways to make and use the invention and are not intended to limit the scope of the invention. Rather, as will be appreciated by one of skill in the art, the teachings and disclosures herein can be combined or rearranged with other portions of this disclosure along with the knowledge of one of ordinary skill in the art.

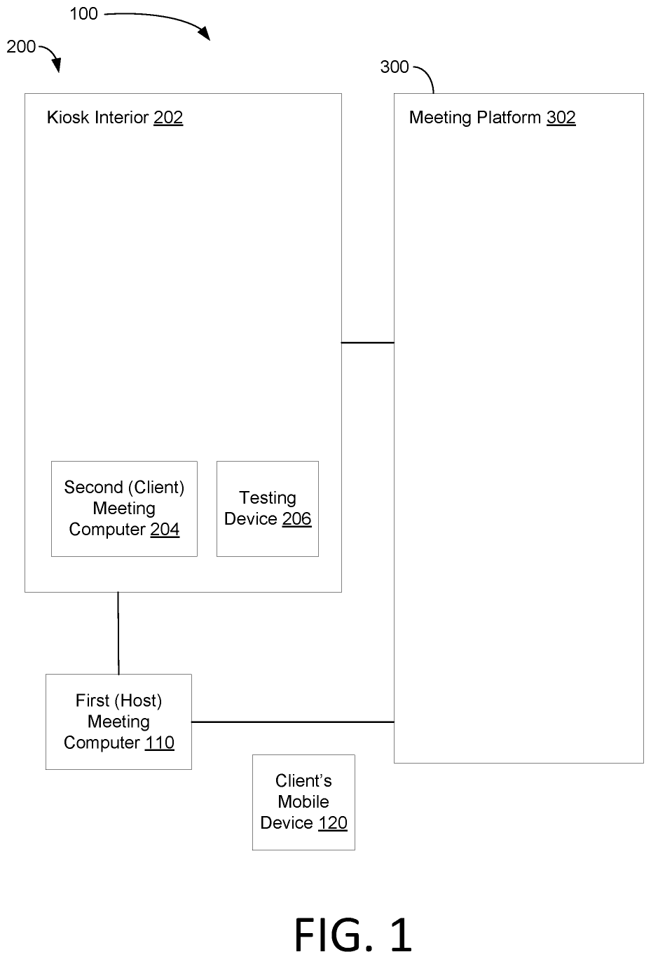

FIG. 1 is a block diagram schematically illustrating an example of a meeting system between a host and a client/individual/user. The meeting system 100 includes a kiosk 200, a meeting server 300 providing a meeting server platform 302 or meeting server 300, and a first (host) meeting computer 110 which are in communication with each other. The kiosk 200 includes a kiosk interior 202 in which a second (client/person) meeting computer 204 and a testing device 206 are disposed. The client has a mobile device 120 which may be used for communication with, for instance, the meeting server 300.

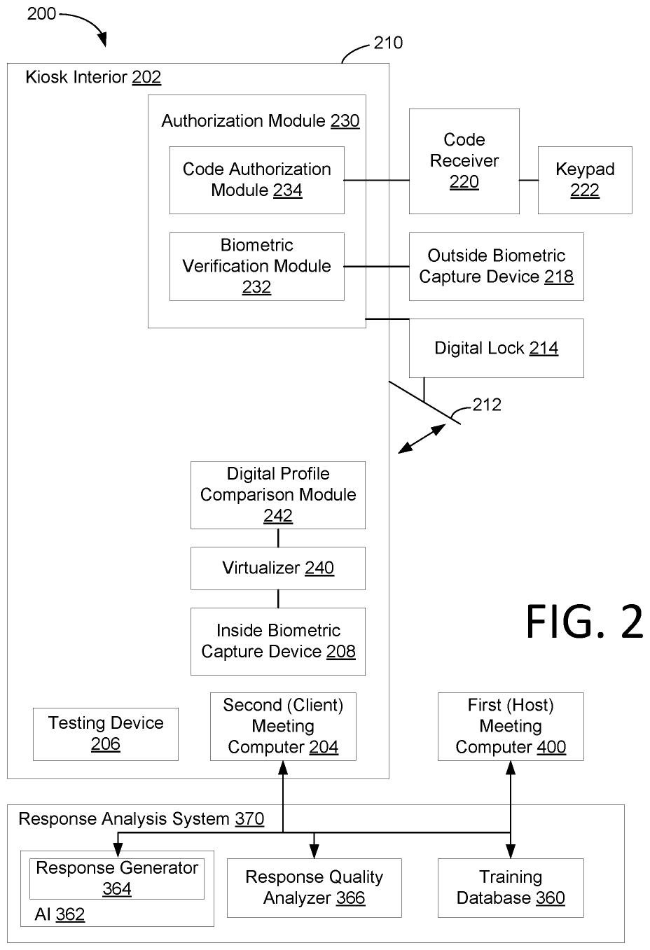

FIG. 2 is a block diagram schematically illustrating elements of a kiosk 200 in the meeting system 100 of FIG. 1 according to an embodiment. The second (client/person) meeting computer 204 includes software to connect to the meeting server platform 302. An inside biometric capture device 208 is disposed in the kiosk interior 202 to capture inside biometric information of the client/person when the client/person is in the kiosk interior 202.

The kiosk interior 202 is bounded or surrounded or otherwise defined by an external barrier or wall 210. The barrier 210 prevents unauthorized access into the kiosk interior 202. The kiosk 200 includes an access portal 212 for entry into and exit from the kiosk interior 202. The access portal 212 may include a door or panel capable of being opened and closed by application of mechanical force on a handle, pad, knob, or the like. A digital lock 214 is connected to the access portal 212 to lock the access portal and to allow the client/person to enter a code to unlock the access portal 212 and gain access to the kiosk interior 202. The digital lock 214 has a locked state and an unlocked state. In the locked state, the access portal 212 is locked and cannot be opened by the client/person by application of a mechanical force on the handle, pad, or knob without causing damage to the access portal 212 or digital lock 214. In the unlocked state, the access portal 212 is unlocked and can be opened without causing damage to the access portal 212 or digital lock 214.

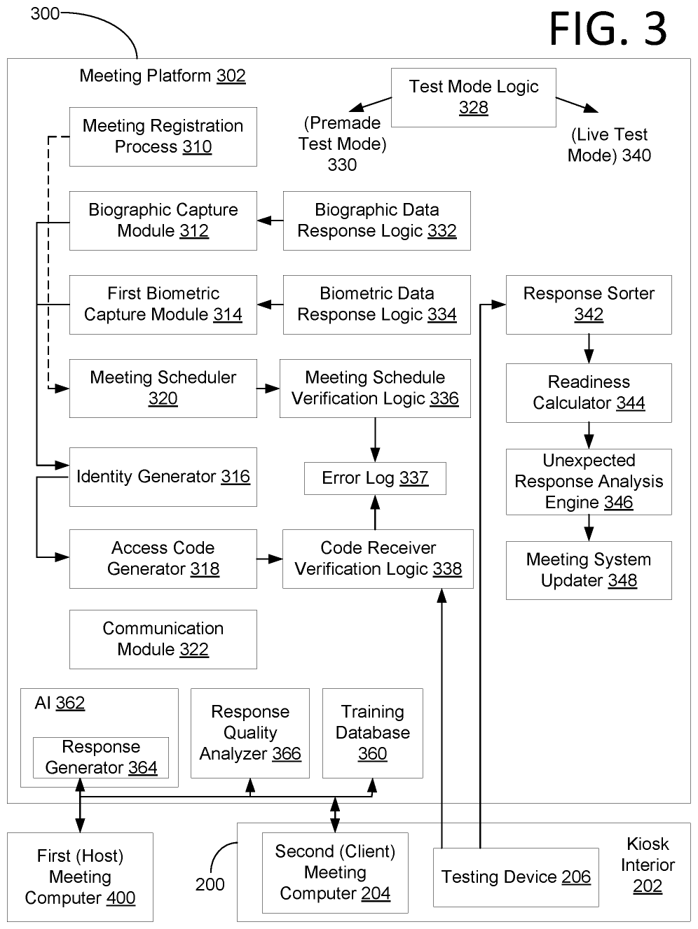

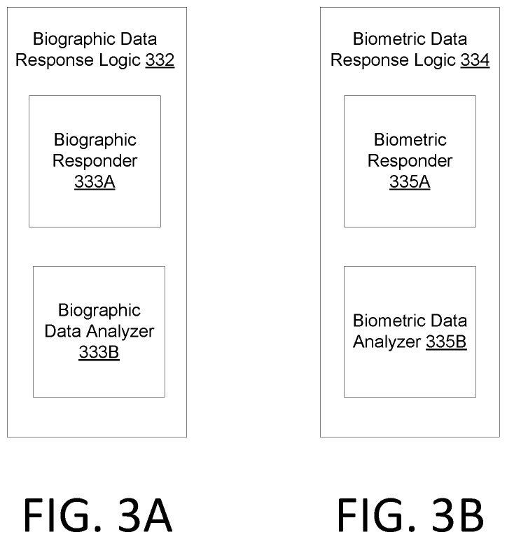

FIG. 3 is a block diagram schematically illustrating elements of a meeting server 300 in the meeting system 100 of FIG. 1 according to an embodiment. The meeting server platform 302 includes a meeting registration process unit 310 configured to receive or collect meeting registration data including, for example, proposal of or availability for meeting date, meeting time, and meeting location, for a client to meet online with a host. A biographic capture module 312 is configured to receive biographic information from the client prior to the meeting including, for example, name, email address, home phone number, and a mobile phone number. A first biometric capture module 314 is configured to receive first biometric information from the client prior to the meeting including, for example, a first photograph of the client. An identity generator 316 is configured to use the submitted biographic information and the first biometric information to generate an identity for the client. An access code generator 318 is configured to generate an access code to provide physical access to the kiosk 200. The access code is specific to the client and, as such, may be associated with or linked to the identity of the client generated by the identity generator 316. The meeting server 300 may send the generated access code to the client (e.g., via a communication module 322 to the client's mobile device 120).

A meeting scheduler 320 is configured to use the meeting registration data (e.g., proposal of or availability for meeting date, meeting time, and meeting location) of the meeting registration process unit 310 to schedule the meeting (e.g., the first meeting session). The meeting scheduler 320 may schedule the meeting by matching the proposal of or availability for meeting date and meeting time between the client and the host with the proposal of or availability for kiosks at one or more proposed or available meeting locations. The meeting scheduler 320 may transmit the meeting schedule (e.g., scheduled meeting date, meeting time, and meeting location) to the mobile device 120 of the client. A communication module 322 is configured to facilitate visual and auditory communications between the client (e.g., via the second (client/person) meeting computer 204 only in some embodiments and possibly also the client's mobile device 120 in other embodiments) and the host (e.g., via the first (host) meeting computer 110) in one or more meeting sessions (possibly before/after the meeting session(s) as well).

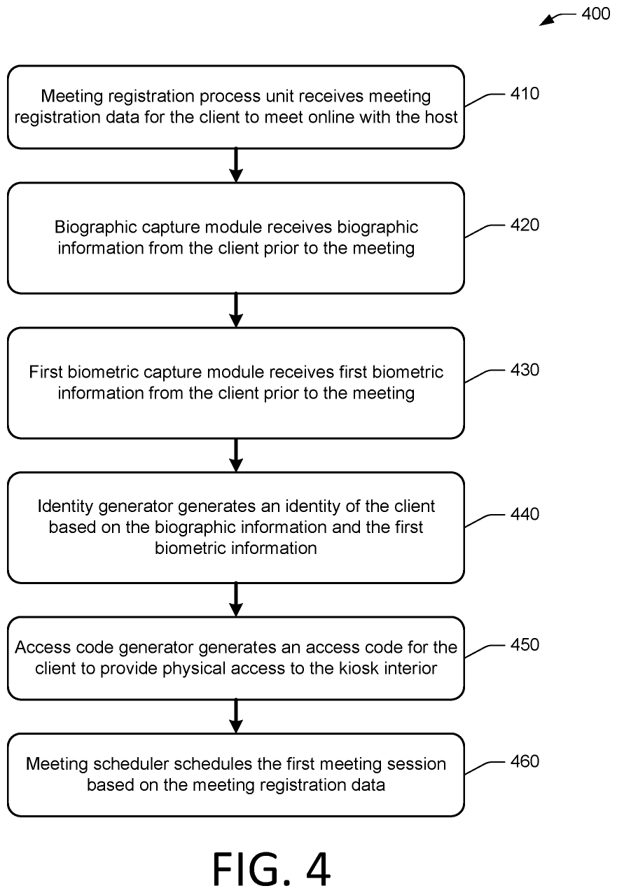

FIG. 4 shows a flow diagram 400 illustrating an example of a meeting setup process by the meeting server 300. In step 410, the meeting registration process unit 310 receives or collects meeting registration data for the client to meet online with the host. In step 420, the biographic capture module 312 receives biographic information from the client prior to the meeting. In step 430, the first biometric capture module 314 receives first biometric information from the client prior to the meeting. In step 440, the identity generator 316 generates an identity for the client based on the submitted biographic information and the first biometric information. In step 450, the access code generator 318 generates an access code to provide physical access to the kiosk interior 202. In step 460, the meeting scheduler 320 schedules the first meeting session based on the meeting registration data.

Referring again to FIG. 2, an outside biometric capture device 218 is configured to obtain outside biometric information of the client/person when the client/person is outside of the kiosk 200. A code receiver 220 is configured to receive a transmitted code from the person outside of the kiosk. A keypad 222 may be provided for receiving the transmitted code from the person outside of the kiosk.

An authorization module 230, which may be disposed in the kiosk interior 202 as shown or outside, is configured to set a state of the digital lock 214 or to change the state of the digital lock 214 from the locked state to the unlocked state. The authorization module 230 may include a biometric verification module 232 configured to determine whether the first biometric information (received by the first biometric capture module 314 from the client/person in advance before the meeting time) matches the outside biometric information (obtained by the outside biometric capture device 218 of the client/person outside of the kiosk) within a preset threshold value (e.g., +10% or +5% or ±1%). A code authorization module 234 is configured to determine whether the access code (generated by the access code generator 318 specific to the client in advance before the meeting time) matches the transmitted code (transmitted from the person outside of the kiosk via the code receiver 220). The person outside of the kiosk is the client authorized to access the kiosk interior 202 if there are a match between the first biometric information and the outside biometric information and a match between the access code and the transmitted code.

Based on the results of the biometric verification module 232 and the code authorization module 234, the authorization module 230 is configured to send a signal to the digital lock 214 to change the state of the digital lock to the unlocked state unless, for instance: (i) the biometric verification module 232 determines the first biometric information and the outside biometric information do not match within the threshold value; (ii) the code authorization module 234 determines the access code does not match the transmitted code; (iii) the code authorization module 234 determines that the transmitted code does not come from the mobile device 120 of the client who received the access code; or (iv) the code authorization module 234 does not receive the transmitted code within a specific time window on a specific date range.

A virtualizer 240 is configured, for instance, to: (i) generate a first digital profile of the person in the kiosk interior 202 based on, for example, facial expressions, clothing, postures, and/or typing speed and accuracy of the person (digital profile keywords may include behavior and physical reactions, facial expressions, behavioral profiling, mannerisms, and reactions, at least some of which may be obtained by the inside biometric capture device 208); (ii) associate the first digital profile of the person with the identity of the client; and (iii) generate a second digital profile of a person if that person enters the kiosk interior 202 for a second meeting session under the identity of the original client.

A digital profile comparison module 242 is configured to determine a digital profile similarity index by analyzing how similar the first digital profile is to the second digital profile (e.g., 1.00 if perfect match). Based on the determination, the digital profile comparison module 242 may be configured to trigger a lockdown process for the kiosk 200 if the digital profile similarity index is below a preset digital profile threshold (e.g., below 0.90 or below 0.95 or below 0.99). The lockdown process may include, for example: disabling use of the second (client/person) meeting computer 204, sounding an alarm, contacting a security system, locking the access portal 212, capturing inside biometric information of the person in the kiosk interior 202, sending a message to the legitimate client (e.g., via the client's mobile device 120) regarding the lockdown process, and/or requesting additional proof of identity from the person in the kiosk interior 202.

As seen in FIG. 3, the meeting system 100 may operate under two modes as provided by the meeting server 300, namely, premade test mode 330 and live test mode 340. The meeting system 100 operates in the premade test mode 330 to verify proper system operation and in the live test mode 340 to interact with the testing device 206 designed to allow the client or person in the kiosk interior 202 to provide live responses to requests generated by the meeting system 100 (e.g., by the meeting server 300). A test mode logic 328 is configured to generate a test mode, i.e., either the premade test mode 330 or the live test mode 340.

In the premade test mode 330, the operation of the meeting server 300 involves a biographic data response logic 332, a biometric data response logic 334, a meeting schedule verification logic 336, and a code receiver verification logic 338.

FIG. 3A shows an example of the biographic data response logic. The biographic data response logic 332 includes a biographic responder 333A configured to generate and transmit synthetic biographic data to the biographic capture module 312 of the meeting server platform 302 and a biographic data analyzer 333B configured to determine whether the synthetic biographic data matches expected biographic data format rules (i.e., a preset format for summarizing or presenting the biographic data to facilitate analysis and comparison).

FIG. 3B shows an example of the biometric data response logic. The biometric data response logic 334 includes a biometric responder 335A configured to provide synthetic biometric data to the first biometric capture module 314 of the meeting server platform 302 and a biometric data analyzer 335B configured to determine whether the synthetic biometric data matches expected quality requirements (e.g., minimum required image resolution, minimum required audio resolution, minimum required DNA purity, or the like) and expected biometric data formats (i.e., a preset format for summarizing or presenting the biometric data to facilitate analysis and comparison). Examples of generating and using synthetic biometric data can be found in Pankaj Bamoriya et al., “DSB-GAN: Generation of deep learning based synthetic biometric data,” Displays, Vol. 74, 102267 (September 2022); Andrey Makrushin et al., “A Survey on Synthetic Biometrics,” IEEE Access, Vol. 10, httpa://www.researchgate.net/publication/368966588_A_Survey_On_Synthetic_biometrics (2022); U.S. Pat. No. 9,674,184, entitled “Systems and Methods to Generate Authorization Data Based on Biometric Data and Non-Biometric Data,” issued to Lae-Hoon Kim; and U.S. Pat. No. 9,430,628, entitled “Access Authorization Based on Synthetic Biometric Data and Non-Biometric Data,” issued to Lae-Hoon Kim et al.; and S. N. Yamushkevich, “Synthetic Biometrics: A Survey,” https://www.researchgate.net/publication/224654421_Synthetic_Biometics_A_Surbey (January 2006). Entire disclosures of these references are incorporated herein by reference.

The meeting schedule verification logic 336 is configured to receive a meeting schedule or a meeting request from the meeting scheduler 320, analyze the meeting schedule or meeting request for errors, and report any errors in an error log 337. A code receiver verification logic 338 is configured to receive a generated access code generated by the access code generator 318, receive a submitted access code from the testing device 206 entered by the client or person in the kiosk interior 202, determine whether the generated access code from the access code generator 318 matches the submitted access code from the testing device 206, and report any errors (if the generated access code and the submitted access code do not match) in the error log 337.

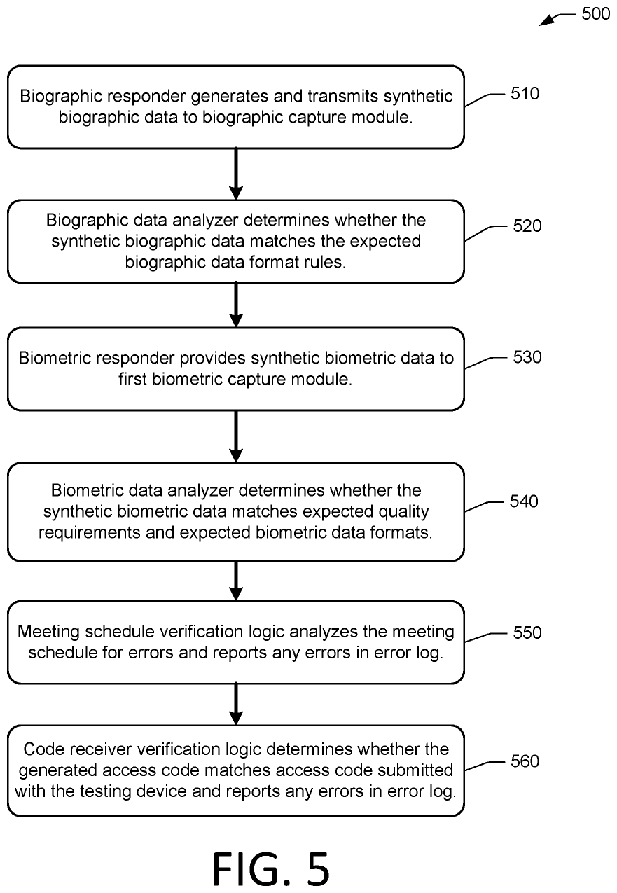

FIG. 5 shows a flow diagram 500 illustrating an example of a premade test mode process. In step 510, the biographic responder 333A generates and transmits synthetic biographic data to the biographic capture module 312 of the meeting server platform 302. In step 520, the biographic data analyzer 333B determines whether the synthetic biographic data matches/meets expected biographic data format rules. In step 530, the biometric responder 335A provides synthetic biometric data to the first biometric capture module 314 of the meeting server platform 302. In step 540, the biometric data analyzer 335B determines whether the synthetic biometric data matches/meets expected quality requirements and expected biometric data formats. In step 550, the meeting schedule verification logic 336 receives a meeting schedule or a meeting request from the meeting scheduler 320, analyzes the meeting schedule or meeting request for errors, and reports any errors in an error log 337. In step 560, the code receiver verification logic 338 receives a generated access code generated by the access code generator 318, receives a submitted access code from the testing device 206 entered by the client or person in the kiosk interior 202, determines whether the generated access code from the access code generator 318 matches the submitted access code from the testing device 206, and reports any errors (if the generated access code and the submitted access code do not match) in the error log 337.

In the live test mode 340, the operation of the meeting server 300 involves a response sorter 342, a readiness calculator 344, an unexpected response analysis engine 346, and a meeting system updater 348.

The response sorter 342 is configured to sort responses received by the meeting server 300 into three categories: predicted pass, predicted fail, or unexpected response. The readiness calculator 344 is configured to determine an unexpected response percentage based on how many responses are unexpected responses relative to a total number of responses collected. The unexpected response analysis engine 346 is configured to analyze one or more sources of the unexpected response and determine what percentage of the unexpected responses have such one or more sources. The sources of unexpected responses may come from software installed on at least one of the following components: the biographic capture module 312, the meeting scheduler 320, the outside biometric capture device 218, or the code receiver 220. The meeting system updater 348 is configured to reduce the unexpected response percentage if the percentage of the unexpected responses is above a preset threshold value (e.g., 5% or 10% or 20%) by proposing an update to the software associated with the source(s) of the unexpected responses. The software update may be designed to reject any data received/obtained by the meeting server 300 (e.g., at least one of the biographic capture module 312, the meeting scheduler 320, the outside biometric capture device 218, and the code receiver 220) that are suspect or do not meet preset quality standards.

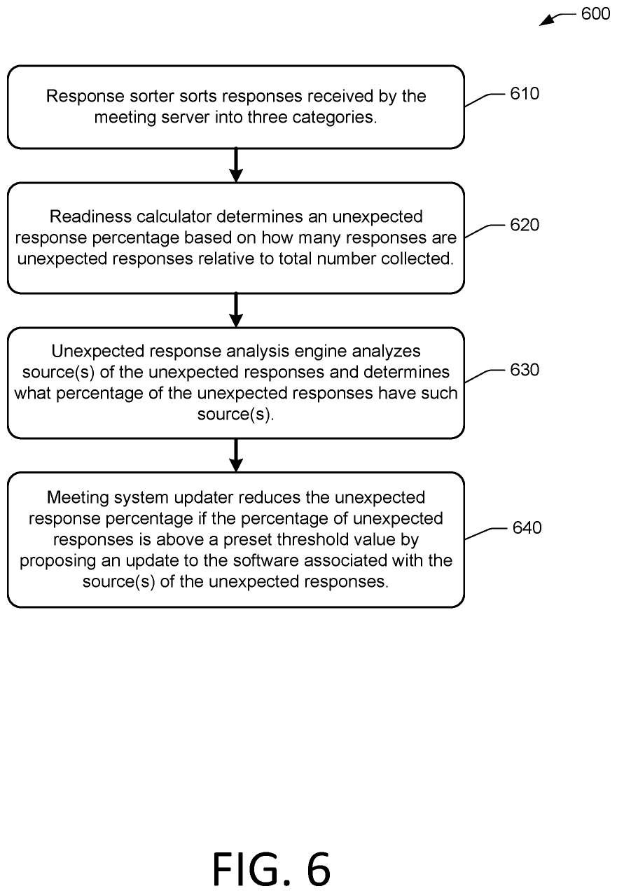

FIG. 6 shows a flow diagram 600 illustrating an example of a live test mode process. In step 610, the response sorter 342 sorts responses received by the meeting server 300 into three categories: predicted pass, predicted fail, or unexpected response. In step 620, the readiness calculator 344 determines an unexpected response percentage based on how many responses are unexpected responses relative to a total number of responses collected. In step 630, the unexpected response analysis engine 346 analyzes one or more sources of the unexpected response and determines what percentage of the unexpected responses have such one or more sources. In step 640, the meeting system updater 348 reduces the unexpected response percentage if the percentage of the unexpected responses is above a preset threshold value (e.g., 5% or 10% or 20%) by proposing an update to the software associated with the source(s) of the unexpected responses.

The first (host) meeting computer may be configured to operate with a human host or an artificial intelligence (host AI). The meeting system 100 may include a training database 360, an artificial intelligence 362 having a response generator 364, and a response quality analyzer 366. They may be provided in the meeting server 300 as shown in FIG. 3 or may be separate units from the meeting server 300 as shown in FIG. 2. In FIG. 2, a response analysis system 370 provides the training database 360, the artificial intelligence 362 having the response generator 364, and the response quality analyzer 366.

The training database 360 includes a data structure of, for instance: (i) questions from the first (host) meeting computer 110 and answers from the second (client/person) meeting computer 204; (ii) statements from the first meeting computer or first computer 110 and replies from the second meeting computer 204; (iii) questions from the second meeting computer 204 and answers from the first meeting computer 110; and/or (iv) statements from the second meeting computer or second computer 204 and replies from the first meeting computer 110.

The artificial intelligence 362 includes the response generator 364 configured to generate responses to inputs from the first meeting computer 110. The responses may be selected from the list consisting of questions, answers, statements, and replies from the first meeting computer 110 and the second meeting computer 204 and stored in the training database 360. The artificial intelligence 362 may be configured to identify a stored input most similar to a current input. The AI 362 may be configured to select a stored response in the training database 360 associated with the stored input in the training database 360.

The response quality analyzer 366 may be configured to determine a response quality of the stored response and, if the response quality is above a preset response quality threshold, send the response to the second meeting computer 204. If the response quality is below the response quality threshold, the response quality analyzer 366 may request a human response at the first (host) meeting computer 110, update the stored response with the human response, and send the human response to the second (client/person) meeting computer 204.

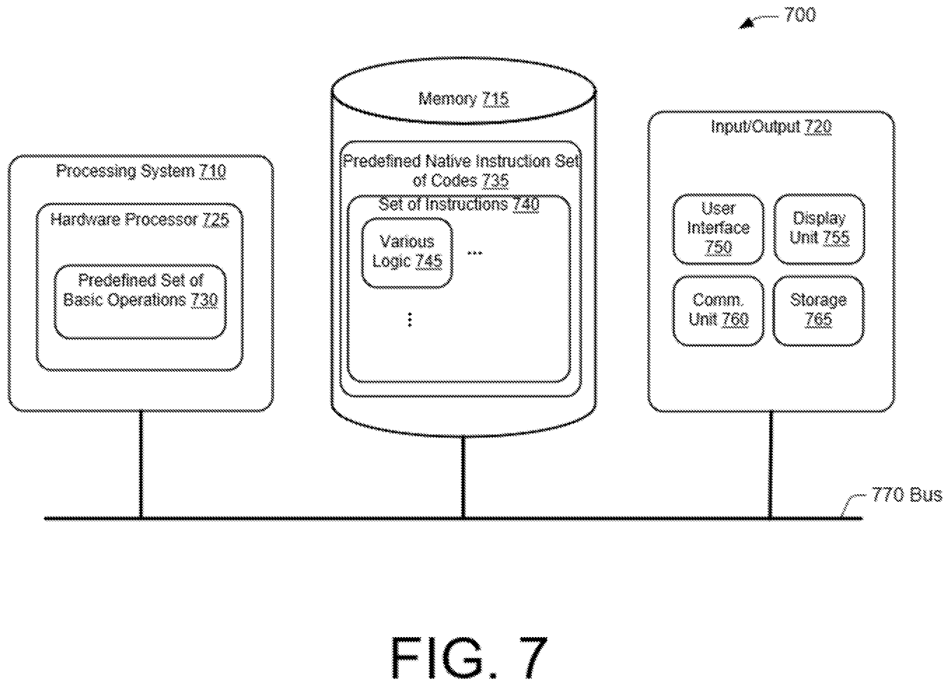

FIG. 7 illustrates a computing system 700 including logic according to an embodiment. The computing system 700 includes a processing system 710 having a hardware processor 725 configured to perform a predefined set of basic operations 730 by loading corresponding ones of a predefined native instruction set of codes 735 as stored in the memory 715. The computing system 700 further includes input/output 720 having user interface 750, display unit 755, communication unit 760, and storage 765. The computing system 700 can be used to implement some or all of the processes or operations of the kiosk 200 in FIG. 2 and the meeting server 300 in FIG. 3.

The memory 715 is accessible to the processing system 710 via the bus 770. The memory 715 includes the predefined native instruction set of codes 735, which constitute a set of instructions 740 selectable for execution by the hardware processor 725. In an embodiment, the set of instructions 740 include logic 745 representing various processor logic and/or modules. An example of such logic 745 is set forth in greater detail with respect to the flow diagram illustrated in FIG. 1. Each of the above-mentioned algorithms (e.g., MMWI, neutron imaging, and other detection algorithms and other imaging algorithms) can be a separate system or a module in an overall computer system 700. The various logic 745 is stored in the memory 715 and comprises instructions 740 selected from the predefined native instruction set of codes 735 of the hardware processor 725, adapted to operate with the processing system 710 to implement the process or processes of the corresponding logic 745.

A hardware processor may be thought of as a complex electrical circuit that is configured to perform a predefined set of basic operations in response to receiving a corresponding basic instruction selected from a predefined native instruction set of codes. The predefined native instruction set of codes is specific to the hardware processor; the design of the processor defines the collection of basic instructions to which the processor will respond, and this collection forms the predefined native instruction set of codes. A basic instruction may be represented numerically as a series of binary values, in which case it may be referred to as a machine code. The series of binary values may be represented electrically, as inputs to the hardware processor, via electrical connections, using voltages that represent either a binary zero or a binary one. These voltages are interpreted as such by the hardware processor. Executable program code may therefore be understood to be a set of machine codes selected from the predefined native instruction set of codes. A given set of machine codes may be understood, generally, to constitute a module. A set of one or more modules may be understood to constitute an application program or “app.” An app may interact with the hardware processor directly or indirectly via an operating system. An app may be part of an operating system.

A computer program product is an article of manufacture that has a computer-readable medium with executable program code that is adapted to enable a processing system to perform various operations and actions. Non-transitory computer-readable media may be understood as a storage for the executable program code. Whereas a transitory computer-readable medium holds executable program code on the move, a non-transitory computer-readable medium is meant to hold executable program code at rest. Non-transitory computer-readable media may hold the software in its entirety, and for longer duration, compared to transitory computer-readable media that holds only a portion of the software and for a relatively short time. The term, “non-transitory computer-readable medium,” specifically excludes communication signals such as radio frequency signals in transit. The following forms of storage exemplify non-transitory computer-readable media: removable storage such as a USB disk, a USB stick, a flash disk, a flash drive, a thumb drive, an external SSD, a compact flash card, an SD card, a diskette, a tape, a compact disc, an optical disc; secondary storage such as an internal hard drive, an internal SSD, internal flash memory, internal non-volatile memory, internal DRAM, ROM, RAM, and the like; and the primary storage of a computer system.

Different terms may be used to express the relationship between executable program code and non-transitory computer-readable media. Executable program code may be written on a disc, embodied in an application-specific integrated circuit, stored in a memory chip, or loaded in a cache memory, for example. Herein, the executable program code may be said, generally, to be “in” or “on” a computer-readable media. Conversely, the computer-readable media may be said to store, to include, to hold, or to have the executable program code.

The inventive concepts taught by way of the examples discussed above are amenable to modification, rearrangement, and embodiment in several ways. For example, this invention may be applicable for other communications that employ a locked kiosk. Accordingly, although the present disclosure has been described with reference to specific embodiments and examples, persons skilled in the art will recognize that changes may be made in form and detail without departing from the spirit and scope of the disclosure.

Certain attributes, functions, steps of methods, or sub-steps of methods described herein may be associated with physical structures or components, such as a module of a physical device that, in implementations in accordance with this disclosure, make use of instructions (e.g., computer executable instructions) that are embodied in hardware, such as an application specific integrated circuit, or that may cause a computer (e.g., a general-purpose computer) executing the instructions to have defined characteristics. There may be a combination of hardware and software such as processor implementing firmware, software, and so forth so as to function as a special purpose computer with the ascribed characteristics. For example, in embodiments a module may comprise a functional hardware unit (such as a self-contained hardware or software or a combination thereof) designed to interface the other components of a system such as through use of an API. In embodiments, a module is structured to perform a function or set of functions, such as in accordance with a described algorithm. This disclosure may use nomenclature that associates a component or module with a function, purpose, step, or sub-step to identify the corresponding structure which, in instances, includes hardware and/or software that function for a specific purpose. For any computer-implemented embodiment, “means plus function” elements will use the term “means;” the terms “logic” and “module” and the like have the meaning ascribed to them above, if any, and are not to be construed as means.

An interpretation under 35 U.S.C. § 112(f) is desired only where this description and/or the claims use specific terminology historically recognized to invoke the benefit of interpretation, such as “means,” and the structure corresponding to a recited function, to include the equivalents thereof, as permitted to the fullest extent of the law and this written description, may include the disclosure, the accompanying claims, and the drawings, as they would be understood by one of skill in the art.

To the extent the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter. To the extent headings are used, they are provided for the convenience of the reader and are not to be taken as limiting or restricting the systems, techniques, approaches, methods, devices to those appearing in any section. Rather, the teachings and disclosures herein can be combined, rearranged, with other portions of this disclosure and the knowledge of one of ordinary skill in the art. It is the intention of this disclosure to encompass and include such variation.

The indication of any elements or steps as “optional” does not indicate that all other or any other elements or steps are mandatory. The claims define the invention and form part of the specification. Limitations from the written description are not to be read into the claims.

1. A meeting system for communication between a client and a host,
the meeting system comprising:
a meeting server configured to provide a meeting server platform;
a first computer configured to connect to the meeting server;
a secure meeting kiosk for providing a connection to the meeting server, the secure meeting kiosk including a kiosk interior for a person to enter to attend a first meeting session, the secure meeting kiosk including an access portal for entry into and exit from the kiosk interior;
a second computer disposed inside the secure meeting kiosk and configured to connect to the meeting server;
a digital lock connected to the access portal to lock the access portal in a locked state and unlock the access portal in an unlocked state;
an external biometric capture device configured to obtain outside biometric information of the person when the person is outside of the kiosk interior, the digital lock switching between the unlocked state and the locked state based at least in part on the outside biometric information obtained by the external biometric capture device;
a first biometric capture module configured to receive first biometric information from the client; and
an authorization module configured to change a state of the digital lock between the locked state and the unlocked state, the authorization module including a biometric verification module configured to determine whether the first biometric information received by the first biometric capture module from the client matches the outside biometric information obtained by the outside biometric capture device of the person, the authorization module setting the digital lock to the locked state when the first biometric information does not match the outside biometric information.

2. (canceled)

3. The meeting system of claim 1, wherein the meeting server platform includes an access code generator configured to generate and provide an access code to the client to provide physical access to the kiosk interior, the meeting system further comprising:
a code receiver is configured to receive a transmitted code from the person when the person is outside of the kiosk interior;
wherein the authorization module further includes a code authorization module configured to determine whether the access code generated by the access code generator and provided to the client matches the transmitted code received by the code receiver from the person when the person is outside of the kiosk interior.

4. The meeting system of claim 1, further comprising:
a virtualizer configured to generate a first digital profile of the person in the kiosk interior, associate the first digital profile of the person with an identity of the person, and generate a second digital profile of the person if the person enters the kiosk to attend a second meeting session; and
a digital profile comparison module configured to determine a digital profile similarity index by analyzing how similar the first digital profile is to the second digital profile;
the digital profile comparison module configured to trigger a lockdown process if the digital profile similarity index is below a preset digital profile threshold.

5. The meeting system of claim 4, further comprising:
an inside biometric capture device disposed in the kiosk interior to capture inside biometric information of the person when the person is in the kiosk interior;
wherein the lockdown process includes one or more of disabling use of the second computer, sounding an alarm, contacting a security system, locking the access portal, capturing the inside biometric information of the person in the kiosk interior, sending a message to the client regarding the lockdown process, or requesting additional proof of identity from the person in the kiosk interior.

6. A meeting system for communication between a client and a host, the meeting system comprising:
a meeting server configured to provide a meeting server platform;
a first computer configured to connect to the meeting server;
a secure meeting kiosk for providing a connection to the meeting server, the secure meeting kiosk including a kiosk interior for a person to enter to attend a first meeting session, the secure meeting kiosk including an access portal for entry into and exit from the kiosk interior;
a second computer disposed inside the secure meeting kiosk and configured to connect to the meeting server;
a digital lock connected to the access portal to lock the access portal in a locked state and unlock the access portal in an unlocked state; and
an external biometric capture device configured to obtain outside biometric information of the person when the person is outside of the kiosk interior, the digital lock switching between the unlocked state and the locked state based at least in part on the outside biometric information obtained by the external biometric capture device;
the meeting server platform including:
a meeting registration process unit configured to receive meeting registration data for the client to meet online with the host;
a biographic capture module configured to receive biographic information from the client;
a first biometric capture module configured to receive first biometric information from the client;
an identity generator configured to generate an identity of the client based on the biographic information and the first biometric information;
an access code generator configured to generate and provide an access code to the client having the identity to provide physical access to the kiosk interior;
a code receiver configured to receive a transmitted code from the person when the person is outside of the kiosk interior;
a code authorization module configured to determine whether the access code generated by the access code generator and provided to the client matches the transmitted code received by the code receiver from the person when the person is outside of the kiosk interior; and
a meeting scheduler configured to schedule the first meeting session based on the meeting registration data.

7. The meeting system of claim 6, further comprising a testing device disposed in the kiosk interior, wherein the meeting server further comprises a test mode logic configured to generate a premade test mode or a live test mode and, for the premade test mode:
a biographic data response logic having a biographic responder configured to generate and transmit synthetic biographic data to the biographic capture module of the meeting server platform and a biographic data analyzer configured to determine whether the synthetic biographic data matches one or more expected biographic data format rules;
a biometric data response logic having a biometric responder configured to provide synthetic biometric data to the first biometric capture module of the meeting server platform and a biometric data analyzer configured to determine whether the synthetic biometric data matches one or more expected quality requirements and one or more expected biometric data formats;
a meeting schedule verification logic configured to receive a meeting request from the meeting scheduler, analyze the meeting request for errors, and report any errors in an error log; and
a code receiver verification logic configured to receive a generated access code generated by the access code generator, receive a submitted access code from the testing device entered by the person in the kiosk interior, determine whether the generated access code from the access code generator matches the submitted access code from the testing device, and report in the error log any errors if the generated access code and the submitted access code do not match.

8. The meeting system of claim 6, further comprising a testing device disposed in the kiosk interior, wherein the meeting server further comprises a test mode logic configured to generate a premade test mode or a live test mode and, for the live test mode:
a response sorter configured to sort responses received by the meeting server into three categories of predicted pass, predicted fail, or unexpected response;
a readiness calculator configured to determine an unexpected response percentage based on how many responses are unexpected responses relative to a total number of responses collected;
an unexpected response analysis engine configured to analyze one or more sources of the unexpected responses and determine what percentage of the unexpected responses have the one or more sources; and
a meeting system updater configured to reduce the unexpected response percentage if the percentage of the unexpected responses is above a preset threshold value by proposing an update to software associated with each source of the one or more sources of the unexpected responses.

9. The meeting system of claim 6, further comprising:
a training database including a data structure of at least one of: (i) questions from the first computer and answers from the second computer, (ii) statements from the first computer and replies from the second computer, (iii) questions from the second computer and answers from the first computer; or (iv) statements from the second computer and replies from the first computer;
an artificial intelligence including a response generator configured to generate responses to inputs from the first computer, the artificial intelligence being configured to identify a stored input most similar to a current input to which the response generator is to generate a response and to select a stored response in the training database associated with the stored input in the training database; and
a response quality analyzer configured to determine a response quality of the stored response and, if the response quality is above a preset response quality threshold, send the response to the second computer and, if the response quality is below the preset response quality threshold, request a human response at the first computer, update the stored response with the human response, and send the human response to the second computer.

10. The meeting system of claim 9,
wherein the responses generated by the response generator include one or more of questions, answers, statements, and replies from the first computer and the second computer and stored in the training database.

11. A meeting system for communication between a client and a host,
the meeting system comprising:
a meeting server configured to provide a meeting server platform;
a first computer configured to connect to the meeting server;
a secure meeting kiosk for providing a connection to the meeting server, the secure meeting kiosk including a kiosk interior for a person to enter to attend a first meeting session, the secure meeting kiosk including an access portal for entry into and exit from the kiosk interior;
a second computer disposed inside the secure meeting kiosk and configured to connect to the meeting server; and
an inside biometric capture device disposed in the kiosk interior to capture inside biometric information of the person when the person is in the kiosk interior;
the meeting server platform including:
a meeting registration process unit configured to receive meeting registration data for the client to meet online with the host;
a biographic capture module configured to receive biographic information from the client;
a first biometric capture module configured to receive first biometric information from the client;
an identity generator configured to generate an identity of the client based on the biographic information and the first biometric information;
an access code generator configured to generate and provide an access code to the client having the identity to provide physical access to the kiosk interior;
a meeting scheduler configured to schedule the first meeting session based on the meeting registration data; and
a test mode logic configured to generate a test mode for the meeting system to operate in (i) a premade test mode to verify proper system operation of the meeting system or (ii) a live test mode to allow the person in the kiosk interior to provide live responses to requests generated by the meeting system.

12. The meeting system of claim 11, further comprising a testing device disposed in the kiosk interior, wherein for the premade test mode, the meeting server further comprises:
a biographic data response logic having a biographic responder configured to generate and transmit synthetic biographic data to the biographic capture module of the meeting server platform and a biographic data analyzer configured to determine whether the synthetic biographic data matches one or more expected biographic data format rules;
a biometric data response logic having a biometric responder configured to provide synthetic biometric data to the first biometric capture module of the meeting server platform and a biometric data analyzer configured to determine whether the synthetic biometric data matches one or more expected quality requirements and one or more expected biometric data formats;
a meeting schedule verification logic configured to receive a meeting request from the meeting scheduler, analyze the meeting request for errors, and report any errors in an error log; and
a code receiver verification logic configured to receive a generated access code generated by the access code generator, receive a submitted access code from the testing device entered by the person in the kiosk interior, determine whether the generated access code from the access code generator matches the submitted access code from the testing device, and report in the error log any errors if the generated access code and the submitted access code do not match.

13. The meeting system of claim 11, wherein for the live test mode, the meeting server further comprises:
a response sorter configured to sort responses received by the meeting server into three categories of predicted pass, predicted fail, or unexpected response;
a readiness calculator configured to determine an unexpected response percentage based on how many responses are unexpected responses relative to a total number of responses collected;
an unexpected response analysis engine configured to analyze one or more sources of the unexpected responses and determine what percentage of the unexpected responses have the one or more sources; and
a meeting system updater configured to reduce the unexpected response percentage if the percentage of the unexpected responses is above a preset threshold value by proposing an update to software associated with each source of the one or more sources of the unexpected responses.

14. The meeting system of claim 11, further comprising:
a training database including a data structure of at least one of: (i) questions from the first computer and answers from the second computer, (ii) statements from the first computer and replies from the second computer, (iii) questions from the second computer and answers from the first computer; or (iv) statements from the second computer and replies from the first computer;
an artificial intelligence including a response generator configured to generate responses to inputs from the first computer, the artificial intelligence being configured to identify a stored input most similar to a current input to which the response generator is to generate a response and to select a stored response in the training database associated with the stored input in the training database; and
a response quality analyzer configured to determine a response quality of the stored response and, if the response quality is above a preset response quality threshold, send the response to the second computer and, if the response quality is below the preset response quality threshold, request a human response at the first computer, update the stored response with the human response, and send the human response to the second computer.

15. The meeting system of claim 14,
wherein the responses generated by the response generator include one or more of questions, answers, statements, and replies from the first computer and the second computer and stored in the training database.

16. A meeting method for communication between a host using a first computer and a client using a second computer which is disposed in a secure meeting kiosk in a meeting system, the secure meeting kiosk including a kiosk interior for a person to enter to attend a first meeting session, the secure meeting kiosk including an access portal for entry into and exit from the kiosk interior, the first computer and the second computer connected with a meeting server providing a meeting server platform, the meeting method comprising:
receiving, by the meeting server, meeting registration data for the client to meet online with the host;
receiving, by the meeting server, biographic information from the client;
receiving, by the meeting server, first biometric information from the client;
generating an identity of the client, by the meeting server, based on the biographic information and the first biometric information;
generating and providing, by the meeting server, an access code to the client having the identity to provide physical access to the kiosk interior;
determining whether the access code generated by an access code generator and provided to the client matches a transmitted code received by a code receiver from the person when the person is outside of the kiosk interior;
scheduling the first meeting session, by the meeting server, based on the meeting registration data; and
generating, by the meeting server, a test mode for the meeting system to operate in (i) a premade test mode to verify proper system operation of the meeting system or (ii) a live test mode to allow the person in the kiosk interior to provide live responses to requests generated by the meeting system.

17. The meeting method of claim 16, for the premade test mode, the method further comprising:
generating, by the meeting server, synthetic biographic data;
determining, by the meeting server, whether the synthetic biographic data matches one or more expected biographic data format rules;
providing, by the meeting server, synthetic biometric data;
determining, by the meeting server, whether the synthetic biometric data matches one or more expected quality requirements and one or more expected biometric data formats;
receiving, by the meeting server, a meeting request, analyzing the meeting request for errors, and reporting any errors in an error log; and
receiving, by the meeting server, a generated access code generated by the access code generator, receiving a submitted access code from a testing device disposed in the kiosk interior entered by the person in the kiosk interior, determining whether the generated access code from the access code generator matches the submitted access code from the testing device, and reporting in the error log any errors if the generated access code and the submitted access code do not match.

18. The meeting method of claim 16, for the live test mode, the method further comprising:
sorting, by the meeting server, responses received by the meeting server into three categories of predicted pass, predicted fail, or unexpected response;
determining, by the meeting server, an unexpected response percentage based on how many responses are unexpected responses relative to a total number of responses collected;
analyzing, by the meeting server, one or more sources of the unexpected responses and determine what percentage of the unexpected responses have the one or more sources; and
reducing, by the meeting server, the unexpected response percentage if the percentage of the unexpected responses is above a preset threshold value by proposing an update to software associated with each source of the one or more sources of the unexpected responses.

19. The meeting method of claim 16, further comprising:
generating, by the meeting server, responses to inputs from the first computer;
identifying, by the meeting server, a stored input most similar to a current input to which the meeting server is to generate a response and selecting a stored response in a training database associated with the stored input in the training database; and
determining, by the meeting server, a response quality of the stored response and, if the response quality is above a preset response quality threshold, sending the response to the second computer and, if the response quality is below the preset response quality threshold, requesting human response at the first computer, updating the stored response with the human response, and sending the human response to the second computer;
the training database including a data structure of at least one of: (i) questions from the first computer and answers from the second computer, (ii) statements from the first computer and replies from the second computer, (iii) questions from the second computer and answers from the first computer; or (iv) statements from the second computer and replies from the first computer.

20. The meeting method of claim 19,
wherein the responses generated by the meeting server include one or more of questions, answers, statements, and replies from the first computer and the second computer and stored in the training database.

21. The meeting method of claim 16, further comprising:
generating, by the meeting server, a first digital profile of the person in the kiosk interior, associating the first digital profile of the person with an identity of the person, and generating a second digital profile of the person if the person enters the kiosk to attend a second meeting session;
determining, by the meeting server, a digital profile similarity index by analyzing how similar the first digital profile is to the second digital profile; and
triggering, by the meeting server, a lockdown process if the digital profile similarity index is below a preset digital profile threshold.

22. The meeting method of claim 21, wherein the lockdown process by the meeting server includes one or more of:
disabling use of the second computer, sounding an alarm, contacting a security system, locking the access portal using a digital lock, capturing inside biometric information of the person using an inside biometric capture device disposed in the kiosk interior, sending a message to the client regarding the lockdown process, or requesting additional proof of identity from the person in the kiosk interior.

23. The meeting method of claim 16, further comprising:
obtaining outside biometric information of the person when the person is outside of the kiosk interior;
determining whether the first biometric information received from the client matches the outside biometric information of the person;
setting a digital lock connected to the access portal to lock the access portal in a locked state when the first biometric information from the client does not match the outside biometric information; and
setting the digital lock to unlock the access portal in an unlocked state when the first biometric information from the client matches the outside biometric information.

24. The meeting method of claim 16, further comprising:
generating a first digital profile of the person in the kiosk interior, associating the first digital profile of the person with an identity of the person, and generating a second digital profile of the person if the person enters the kiosk to attend a second meeting session;
determining a digital profile similarity index by analyzing how similar the first digital profile is to the second digital profile; and
triggering a lockdown process if the digital profile similarity index is below a preset digital profile threshold.

25. The meeting system of claim 6, further comprising:
a virtualizer configured to generate a first digital profile of the person in the kiosk interior, associate the first digital profile of the person with an identity of the person, and generate a second digital profile of the person if the person enters the kiosk to attend a second meeting session; and
a digital profile comparison module configured to determine a digital profile similarity index by analyzing how similar the first digital profile is to the second digital profile;
the digital profile comparison module configured to trigger a lockdown process if the digital profile similarity index is below a preset digital profile threshold.
